(19) United States
(12) Patent Application Publication
(10) Pub. No.: US 2017/0160794 A1
(43) Pub. Date: Jun. 8, 2017

(54) SYSTEM COMPRISING A HEADSET EQUIPPED WITH A DISPLAY DEVICE AND DOCUMENTATION DISPLAY AND MANAGEMENT MEANS

(71) Applicant: THALES, Courbevoie (FR)

(72) Inventors: Xavier SERVANTIE, Pessac (FR); Laurent LALUQUE, Bordeaux (FR); Cecile ANDRE, Bordeaux (FR)

(73) Assignee: THALES, Courbevoie (FR)

(21) Appl. No.: 15/121,762

(22) PCT Filed: Feb. 13, 2015
(86) PCT No.: PCT/EP2015/053147

§ 371 Date: Jan. 9, 2017

(30) Foreign Application Priority Data
Feb. 28, 2014 (FR) 1400506

(51) Int. Cl. G06F 3/01; G02B 27/01

(52) U.S. Cl. CPC G06F 3/012; G02B 27/017; G02B 2027/0187

(57) ABSTRACT

The general field of the invention is that of headset viewing systems comprising at least one headset equipped with a viewing device and a system for detecting posture of said headset with respect to a known reference frame. The viewing system according to the invention comprises a documentary data base and means for displaying and managing said documentary data as a function of the posture of the headset.

The field of the invention is that of headset viewing systems, used in particular in the aeronautical field.

Headset viewing systems have commonly been used for aeronautical applications for several decades. A headset viewing system mainly comprises two sub-assemblies. The first is a headset equipped with a viewing system projecting toward the user's eye or eyes a collimated image superimposed on the exterior. The second is a headset posture detection system making it possible to reference in space, with respect to a known frame of reference, generally tied to an aircraft, the position and the orientation of the headset.

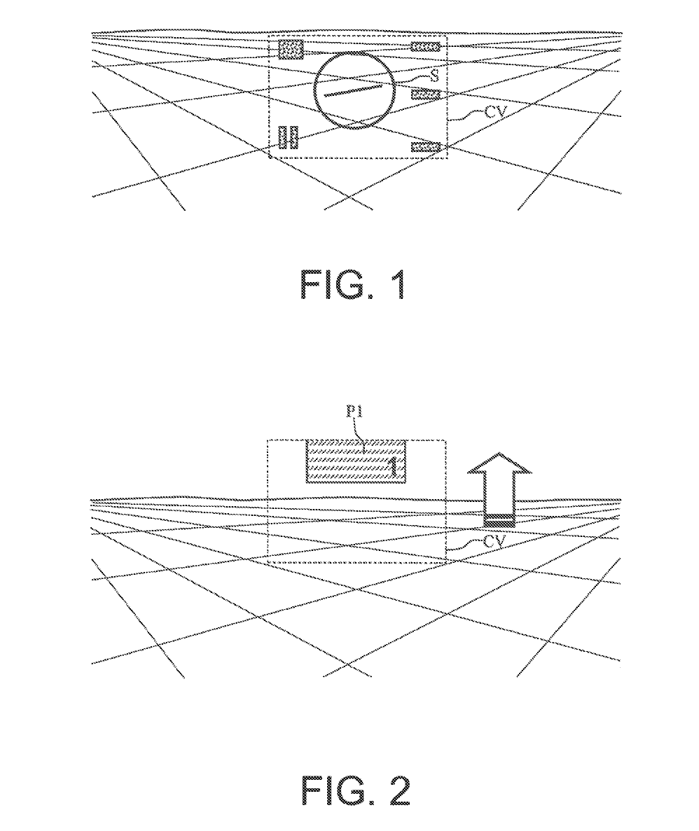

The main function of the headset viewing system is to be able to present, superimposed on the exterior landscape, so-called “conformal” information, that is to say displayed virtually in the exact direction that it would occupy in the exterior landscape. Thus, if the system displays a video image arising from a sensor and comprising a certain number of objects, the objects represented of this image are exactly superimposed on the real objects present on the terrain. By way of example, FIG. 1 represents, in a simplified manner the symbology S in the visual field CV of a headset display unit. The exterior landscape is represented in this figure by vanishing lines. The dashed rectangle represents the limits of the visual field of the viewing system.

However, the pilot may be led to consult documentation relating either to his aircraft, or to the flight, or to the mission in progress. This documentation exists either in the form of paper documentation, or, for a few years, has existed in electronic form. This type of electronic equipment is known by the name “EFB”, the acronym standing for “Electronic Flight Bag”. The documentation can also be displayed on the main viewing screens situated on the instrument panel of the cockpit. In all cases, the user must necessarily accommodate in order to pass from external vision to the reading of his documentation which is in paper form or in digital form. Moreover, the information provided by the viewing system is lost. Finally, consultation of paper documentation requires him to release the controls for a few moments.

The object of the invention is to implement novel means making it possible to display and to manage aeronautical documentation through the headset viewing system. In-flight consultation of this documentation is thus significantly simplified, without appreciably modifying the headset viewing system. More precisely, the subject of the invention is a headset viewing system comprising at least one headset equipped with a viewing device and a system for detecting posture of said headset with respect to a known reference frame, characterized in that the viewing system comprises a documentary data base and means for displaying and managing said documentary data as a function of the posture of the headset.

Advantageously, the appearance and the display of said data in the viewing device is conditioned by an orientation of the headset in a determined orientation range.

Advantageously, once they have appeared, the location of the data displayed in the viewing device is fixed in the known reference frame and independent of slight changes of posture of the headset not exceeding a few degrees.

Advantageously, once they have appeared, the data being structured in the form of pages, an entire page being presented in the viewing device, the rightward or leftward changing of pages is performed by modifying the posture of the headset leftward or rightward by at least several degrees.

Advantageously, the display of the data in the viewing device is located at the center and in the top part of the viewing device.

The invention will be better understood and other advantages will become apparent on reading the nonlimiting description which follows and by virtue of the appended figures among which:

FIG. 1 represents a view of a symbology in a headset viewing system according to the prior art;

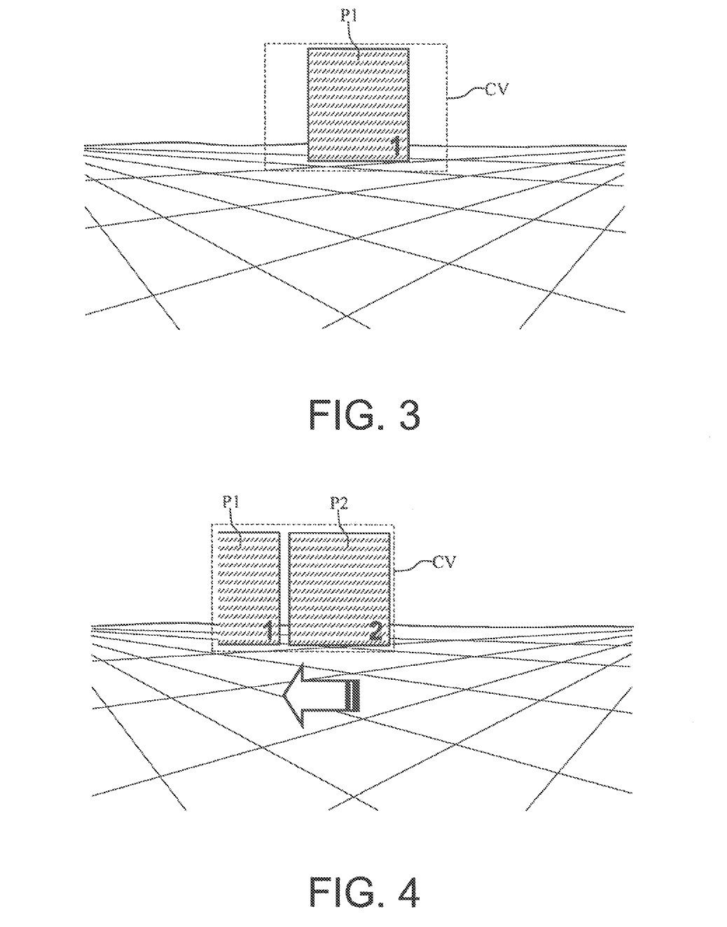

FIGS. 2, 3 and 4 represent the management of the display of the data of the documentary base in a headset viewing system according to the invention.

A headset viewing system according to the invention mainly comprises:
an equipped headset comprising an optoelectronic display assembly. This assembly may be monocular or binocular. When the headset is worn by a user, this assembly gives a collimated image arising from a display unit and superimposed on the exterior landscape by an optical combiner or mixer that may be independent or integrated into the visor;
a system for detecting posture of the headset making it possible to determine the position and the orientation of the headset in the aircraft frame of reference. Various detection systems exist which are well known to the person skilled in the art. Mention will be made of magnetic-detection systems in which a receiver measures the components of a known electromagnetic field and optical-detection systems comprising an emitter and a receiver which is able to determine the position and the orientation of this emitter by shape recognition. The position of the aircraft in a terrestrial frame of reference is itself known by means of various sensors such as the aircraft's inertial platform;
a documentary base of data relating either to the aircraft and its technical characteristics, or to the flight plan or to the mission in progress. By way of example, this base can comprise cartographic data comprising information specific to aeronautics such as airports or aeronautical waypoints, etc;
an electronic assembly or an electronic computer ensuring several functions detailed hereinbelow.

The first function of the electronic computer is to ensure the generation of a conformal symbology superimposed on the exterior landscape by the optoelectronic display assembly. This symbology generally comprises the basic information necessary for piloting such as the indications of the speed, of the altitude, of the attitude, of the horizon, etc. To ensure this function, the various sensors of the aircraft provide the computer with the necessary information. The headset orientation detection system gives it the position and orientation information making it possible to display the symbology in a conformal manner, that is to say in a terrestrial frame of reference independent of the movements of the aircraft and of the movements of the headset.

The second function of the computer, and which is more particularly dedicated to the implementation of the invention, is the management of the display of the data of the documentary base as a function of the posture of the headset.

None of these electronic functions poses any particular difficulties for the person skilled in the art.

By way of example, FIGS. 2, 3 and 4 illustrate the management of the display of the data of the documentary base as a function of the posture of the headset. In these figures, the dashed rectangle represents the limits of the visual field of the viewing system. The arrows are representative of the changes of posture of the headset. The exterior landscape is represented in these figures by vanishing lines.

FIG. 2 illustrates the appearance of the documentary data base in the field of the headset display unit. The base can only appear if the headset has a well determined orientation. This orientation lies in a certain margin of a few degrees. In the case of FIG. 2, the headset is rotated upwards and in the mid-axis of the wearer. When clear, the user does not rotate his head to the left or to the right but only upwards. Page P1 numbered “1” appears. Preferentially, the documentation appears progressively. In FIG. 2, page P1 numbered “1” has appeared in full.

Preferentially, the documentation is tied to the aircraft frame of reference and therefore does not shift in case of slight head movements not exceeding a few degrees.

Preferentially, the documentation is organized in the form of sheets P referenced and/or numbered as seen in FIGS. 2, 3 and 4. Preferentially, a single sheet is visible in the field of the headset display unit. When the documentation appears or reappears, it is possible to display either systematically the first page, or the last page consulted.

The documentation may be consulted in the following manner. The rightward or leftward changing of pages is performed by modifying the posture of the headset leftward or rightward by at least several degrees. This change of page is illustrated in FIG. 4 where progressively page P2 numbered “2” substitutes itself for page P1 numbered “1”, the user having rotated his head to the left. The pages stop scrolling when the user's head reassumes its initial position.

1. A headset viewing system comprising at least one headset equipped with a viewing device and a system for detecting posture of said headset with respect to a known reference frame, the viewing system comprising a documentary data base and means for displaying and managing said documentary data as a function of the posture of the headset, wherein once they have appeared, the data being structured in the form of pages, an entire page being presented in the viewing device, the rightward or leftward changing of pages is performed by modifying the posture of the headset leftward or rightward by at least several degrees.

2. The headset viewing system as claimed in claim 1, wherein the appearance and the display of said data in the viewing device is conditioned by an orientation of the headset in a determined orientation range.

3. The headset viewing system as claimed in claim 1, wherein once they have appeared, the location of the data displayed in the viewing device is fixed in the known reference frame and independent of slight changes of posture of the headset not exceeding a few degrees.

4. The headset viewing system as claimed in claim 1, wherein the display of the data in the viewing device is located at the center and in the top part of the viewing device.
